(19) United States
(12) Patent Application Publication
(10) Pub. No.: US 2015/0189464 A1
(43) Pub. Date: Jul. 2, 2015

(54) Disambiguation of Wireless Data Clusters Using Preclassification

(71) Applicants: Michael Jesse Chu, Los Altos Hills, CA (US); Adel Amin Youssef, Santa Clara, CA (US); Zhengrong Ji, Sunnyvale, CA (US); Steven John Lee, San Francisco, CA (US); Ravi Jain, Palo Alto, CA (US)

(72) Inventors: Michael Jesse Chu, Los Altos Hills, CA (US); Adel Amin Youssef, Santa Clara, CA (US); Zhengrong Ji, Sunnyvale, CA (US); Steven John Lee, San Francisco, CA (US); Ravi Jain, Palo Alto, CA (US)

(73) Assignee: Google Inc., Mountain View, CA (US)

(21) Appl. No.: 12/324,474

(22) Filed: Nov. 26, 2008

Related U.S. Application Data
(60) Provisional application No. 60/990,238, filed on Nov. 26, 2007.
(60) Provisional application No. 60/990,569, filed on Nov. 27, 2007.
(60) Provisional application No. 61/196,167, filed on Oct. 15, 2008.

(51) Int. Cl. H04W 64/00; G01S 5/02; H04W 8/02

(52) U.S. Cl. CPC H04W 4/02; H04W 8/02; G01S 5/0205

(57) ABSTRACT

Systems and methods for determining the geographic location of a user based on limited and ambiguous information available from the user's mobile electronic communication device are provided. In an embodiment, a computer-based system estimates a device's physical location based on partial identification information collected from the device such as the local area code and cell identification number, and numerous non-locational attributes. When the system determines that the collected information from the device corresponds to more than one single geographic location the system may use additional techniques of iterative disambiguation and filtering to determine a predicted location. Additional techniques may be used to increase the confidence level of the predicted location.

### CROSS-REFERENCE TO RELATED APPLICATIONS

This application claims the benefit of U.S. Provisional Application No. 60/990,238 filed Nov. 26, 2007; U.S. Provisional Patent Application No. 60/990,569, filed on Nov. 27, 2007; and U.S. Provisional Patent Application No. 61/196,167, filed on Oct. 15, 2008, which are incorporated herein by reference in their entireties.

### BACKGROUND

1. Field of the Invention

Embodiments of the present invention relate to wireless telecommunications technology.

2. Related Art

Wireless networks, for example wireless cellular networks, have interconnected wireless transmitters and receivers known as wireless base stations (WBSs) spread throughout a coverage area. A WBS may be, for example, a cell tower or a wireless access point such as a WiFi or Bluetooth receiver. The coverage area of a WBS is generally referred to as a cell. A mobile communication device (mobile device) connects to the rest of the network by establishing a communications connection with a selected WBS when it is located in the cell corresponding to the WBS. As the mobile device moves within the carrier's coverage area, it may transition from one cell to another by establishing communications with a WBS corresponding to each cell.

A location based service (LBS) leverages a user's physical location to provide an enhanced service and experience. A server system providing a LBS may obtain the mobile device's physical location with the use of explicit location information such as that provided by a global positioning system (GPS) device and carrier-provided information. The location information may then be used to customize the services provided to the mobile device. Maps of the mobile device's current surrounding area, traffic in the surrounding area, and nearby restaurant lists are some of the more common LBS services that are currently available.

Presently, a mobile positioning technique known as COO, or Cell of Origin, can be used to approximate a caller's cell location. Most commercially implemented COO systems rely on the fact that the mobile devices constantly measure the signal strength from the closest base stations and lock on to the strongest signal. The COO systems consider the location of the base station to be the location of the mobile device. Such an analysis does not deliver an accurate location. A more accurate position can be obtained when COO is used in conjunction with some other technology, such as the Global Positioning System (GPS) or Time of Arrival (TOA).

When accurate information such as GPS is unavailable for determining the current location of a mobile device, a LBS server requires a determination of the position through other means. Not all devices are equipped with a GPS capability. One way to determine the physical location of a mobile device is by identifying the one or more WBSs within whose cell areas the mobile device is located, and then determining the position of the mobile device relative to the fixed locations of those WBSs. Although network carriers have exact location information for all of their owned WBSs, that information is rarely made available to other service providers or users of mobile devices. Therefore, a LBS server must resort to other means for determining the location of a mobile device to which it provides services. Some information may be obtained from the mobile device itself, but such information is often incomplete. What is needed is a system and method for determining the location of a mobile device when only partial or incomplete information regarding the associated WBS cell is received.

### BRIEF SUMMARY

Embodiments of the present invention relate to systems and methods for determining the geographical location of a user with limited and/or ambiguous information associated with the user's mobile device. In an embodiment, a method for determining the geographical location of an end user utilizing information associated with the user's mobile device involves a two step process. The first is a data collection phase in which all possible location information, WBS region identification information and non-location attributes are collected for a number of mobile devices. A geo-calibration algorithm is then executed which determines defined regions associated with like identification information and attributes. The second phase is a lookup phase in which the information accumulated in the collection phase is assessed to identify a region associated with a particular mobile device.

If the mobile device only returns a partial set of identification information for the WBS region, a conflict may occur where two WBS regions can be identified using the partial identification information. In this situation a geographical pre-classification system may analyze non-location attributes of the conflicting WBS regions to determine the proper geographic region associated with each WBS region.

In this way a mobile device's geographic location can be determined with a high degree of confidence using limited and ambiguous information available from the user's wireless communication device.

Further embodiments, features, and advantages of the invention, as well as the structure and operation of the various embodiments of the invention are described in detail below with reference to accompanying drawings.

### BRIEF DESCRIPTION OF THE FIGURES

FIG. 1 illustrates two mobile communication devices communicating with different wireless base stations located in different geographic regions.

FIG. 2 is a flowchart depicting a method for preclassifying locations based on non-location attributes, according to an embodiment of the present invention.

FIG. 3 illustrates a system for determining the geographical location of a mobile device, according to an embodiment of the present invention.

FIG. 4 illustrates a set of attributes that can be used to assist in the determination of the geographical location of a mobile device, according to an embodiment of the present invention.

FIG. 5 is a flowchart depicting a method for determining the geographical location of a mobile device with limited information from the mobile device, according to an embodiment of the present invention.

### DETAILED DESCRIPTION

While specific configurations, arrangements, and steps are discussed, it should be understood that this is done for illustrative purposes only. A person skilled in the pertinent art(s) will recognize that other configurations, arrangements, and steps may be used without departing from the spirit and scope of the present invention. It will be apparent to a person skilled in the pertinent art(s) that this invention may also be employed in a variety of other applications.

It is noted that references in the specification to “one embodiment”, “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to incorporate such a feature, structure, or characteristic in connection with other embodiments whether or not explicitly described.

Embodiments of the present invention relate to the ability to identify the location of a person using a mobile communication device (mobile device). While some devices, such as mobile cellular phones, are equipped with global positioning system (GPS) capabilities, not all devices have such ability. In addition, devices that have built in GPS functionality do not necessarily generate an accurate geographic location. In examples described in this disclosure, information may be gathered by the mobile device which includes partial identification information related to the wireless base station region, as well as non-location based attribute data, both of which can be combined and analyzed to identify the regional location of the user.

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

In an example of a wireless communication system using a Global System for Mobile communication (GSM) cellular network, communication with a mobile device occurs through a wireless base station (WBS). The geographic range covered by the WBS is referred to herein as a cell or region. A cell may correspond to the coverage area of a plurality of wireless technologies including for example and without limitation, GSM, EDGE, IEEE 802.11, and Bluetooth. In some embodiments, a cell may correspond to any area or network that is connected to the carrier network through a WBS. For example, a user network covering an entire building, an adhoc wireless network, a personal area network, or other local area network, may be connected to the carrier network through a WBS. Each WBS region can be uniquely identified using the following four parameters: mobile network code (MNC), mobile country code (MCC), local area code (LAC), and cell identification (CID). The MNC defines the wireless carrier used by the WBS to provide a communication to the mobile device. The MCC defines the country in which the WBS region is located. As an example, an MCC of “505” with an MNC of “03” represents the communications operator Vodafone in Australia on the GSM 900/1800 and UMTS 2100 frequencies. The LAC provides the local area in which the WBS region exists. The CID is the identification number assigned to the WBS region within the local area. For a particular carrier in a particular country, the combination of the LAC and CID uniquely identify an active WBS region. If a complete identifier containing all four parameters (i.e., MNC, MCC, LAC, and CID) is received for a mobile device, then the active WBS region, and thus the location of the mobile device, can be identified. It is possible, however, that different carriers may use the same LAC/CID combination, and/or that WBS regions in different countries may be identified by the same LAC/CID combination. If only a partial identifier containing the LAC and CID is received without the corresponding MNC or MCC, there may be some ambiguity as to which WBS region is active since multiple cells may be identified by the same LAC/CID combination.

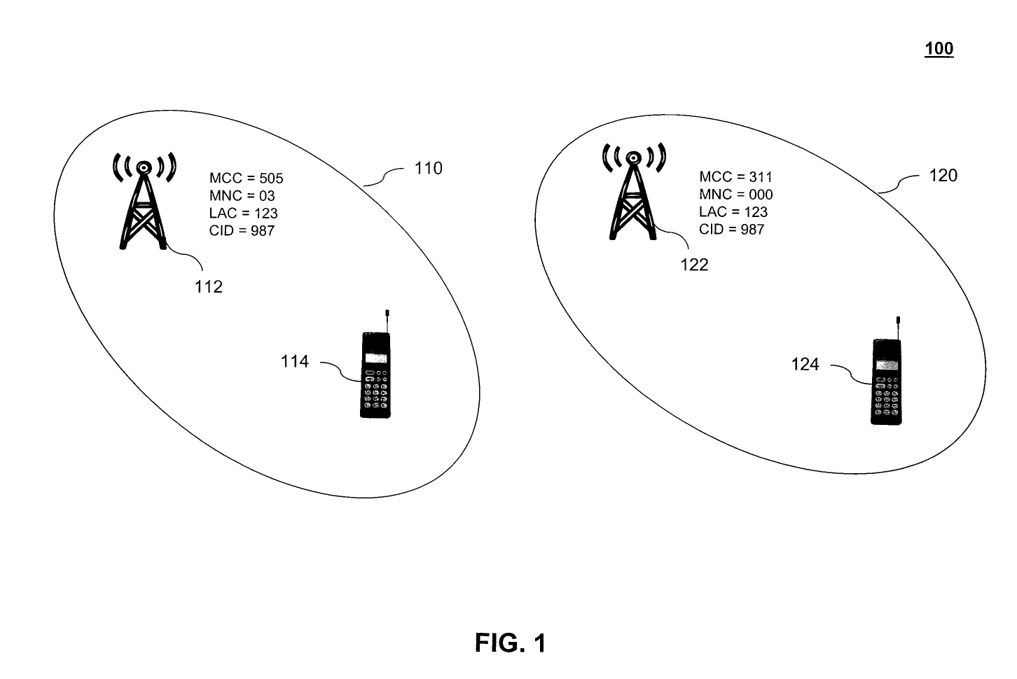

The ambiguity that arises when identical partial information is associated with multiple WBS regions is referred to as a “collision.” FIG. 1 illustrates a situation which may result in such a collision. A first WBS region 110, defined by a WBS 112, has the following identification (ID) parameters: MCC=505, MNC=03, LAC=123, and CID=987. A second WBS region 120, defined by a WBS 122, has the following ID parameters: MCC=311, MNC=000, LAC=123, and CID=987. If a complete identifier containing all four ID parameters is received for a mobile device 114, a location-based service (LBS) can accurately determine that mobile device 114 is located in WBS region 110. Similarly, if a complete identifier containing all four ID parameters is received for a mobile device 124, a LBS can accurately determine that mobile device 124 is located in WBS region 120. While the LAC and CID data received for each of devices 114 and 124 are identical, the WBS's 112 and 122 associated with devices 114 and 124 may be different, as they are in this example, as well as being located in separate geographic regions 110 and 120, respectively. However, a collision may occur if only the LAC and CID are received from either device 114 or device 124, and more than one region is associated with the LAC/CID data pair. This collision may be detected in various ways.

The size of a region may be defined by taking the convex hull of locations determined to be within the region. A first indication that a collision exists occurs when a region R corresponding to a particular partial identifier is much greater than that expected or possible for the region. For example, if the region is expected to have a size consistent with the in-range area of a single WBS, but the region corresponding to the partial identifier spans multiple continents, a collision may be inferred. To detect such collisions, a threshold T may be defined, wherein T is the expected size of a region. If R is greater than T, a collision is inferred.

One difficulty with this type of collision detection is that the threshold T may vary by technology, user population density, carrier, terrain, or other factors. Nonetheless, some generalizations are possible to make approximate inference of collision.

A second indication that a collision exists occurs when a clustering algorithm is run on a region R, and two or more distinct geographic clusters are detected within region R. For example, within a “region 1,” there could be two non-overlapping, or somewhat overlapping, concentrations, e.g., locations, of mobile devices, where “cluster A” is located in the eastern section of region 1 and “cluster B” is located in the western section of region 1. As each region includes multiple locations of individual mobile devices, an analysis of those locations may indicate that the locations typically fall in one of two (or more) clusters. If multiple clusters are detected, a collision is inferred, since it is possible that each cluster corresponds to a different WBS region. False collision detection may occur if a single WBS region actually does include multiple clusters of devices, but such a false positive can be mitigated through further assessment of the data.

When a collision exists, the location of the mobile device from which the partial identification information was received cannot be accurately estimated. However, as will be described below, non-location attributes related to the particular mobile device may be combined with the partial identification information to estimate the location of the mobile device. Preclassification of WBS regions may be consulted in order to assist in determining the actual WBS region in use.

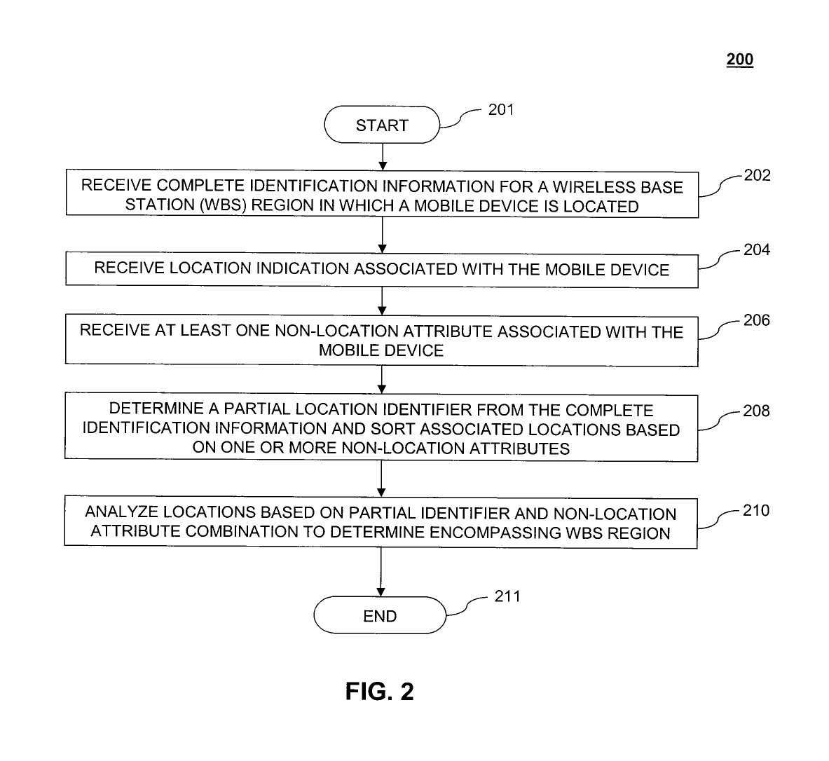

FIG. 2 illustrates a method 200 for collecting and classifying location information received from a plurality of mobile devices. In step 202, complete identification information for a WBS region in which a mobile device is located is received. In an embodiment, the complete identification information includes the MNC, MCC, LAC and CID.

In step 204, a location indication is received for the mobile device. The location indication may be received from, for example, a GPS unit associated with the mobile device. For a mobile device without GPS capability, the location indication may be provided in other ways. For example, the portion of an electronic map being displayed by the mobile device may provide an indication of the mobile device location. Each location indication is indicative of a specific point or location within a larger WBS region.

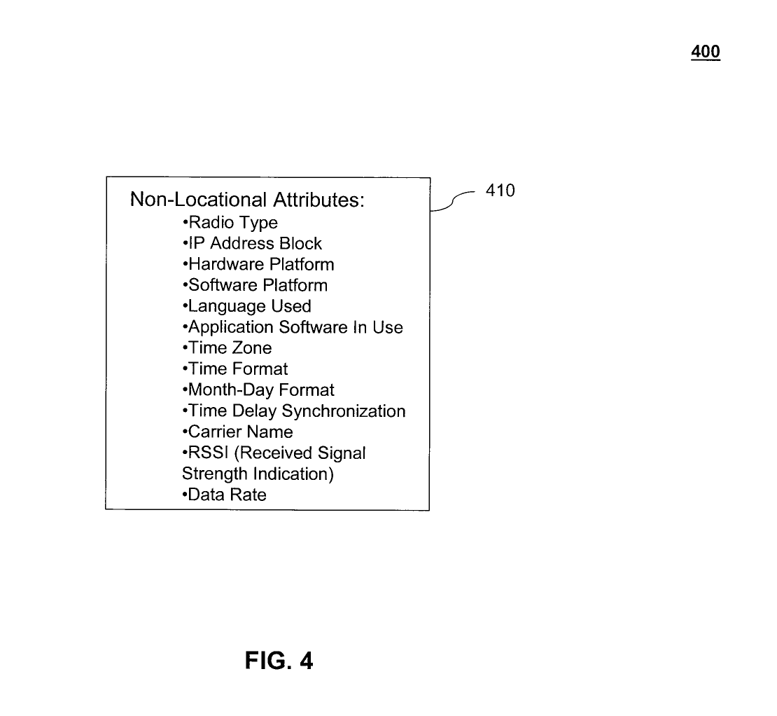

In step 206, at least one non-location attribute is received for the mobile device. FIG. 4 indicates example information that may be used as non-location attributes. As shown in FIG. 4, non-location attributes may include, for example and without limitation, a radio type of the mobile device, an interne protocol (IP) address block used by the mobile device, a hardware platform used by the mobile device, a software platform used by the mobile device, the language used by the mobile device, the application software in use on the mobile device, the time zone indicated by the mobile device, the time format indicated by the mobile device, the month-day format indicated by the mobile device, the time delay synchronization required by the mobile device to communicate with a WBS, a carrier name associated with the mobile device, a received signal strength indication (RSSI) of one or more signals, and a rate of received data.

One of skill in the art will recognize that steps 202, 204, and 206 may occur in any order, and any or all of steps 202, 204, and 206 may occur simultaneously, without departing from the spirit and scope of the present invention. Steps 202, 204, and 206 may be performed for a plurality of mobile devices to obtain information for a number of different locations.

In steps 208 and 210, the received attributes are used to preclassify partial identifiers into corresponding WBS regions.

In step 208, the locations associated with a given partial identifier (e.g., a LAC/CID combination) are sorted based on one or more non-location attributes. In an example, the non-location attribute is the radio type, such as GSM, CDMA, etc. If the set of all radio types is W, then the individual radio types within W are W1, W2, etc. That is, W={W1, W2, . . .}. If the set of locations associated with a given partial identifier is L, the subset L(W1) includes locations associated with the given partial identifier and the radio type W1. Iterative classifications may be made so that each non-location attribute received defines a subset of locations associated with a given partial identifier.

In the example of FIG. 1, the set of locations L associated with the partial identifier <LAC=123, CID=987>includes locations of both mobile device 114 and mobile device 124. However, if the radio type of mobile device 114 is GSM and the radio type of mobile device 124 is CDMA, subset L(GSM) includes only the location of mobile device 114 while subset L(CDMA) includes only the location of mobile device 124.

In step 210, the locations in each subset defined by the partial identifier and non-location attribute combinations are analyzed to determine an encompassing WBS region for each subset. That is, a subset L(W1) is associated with a WBS region R. Continuing with the example from step 208, a subset L(GSM) is associated with WBS region 110 because it includes the location of mobile device 114. Similarly, a subset L(CDMA) is associated with WBS region 120 because it includes the location of mobile device 124. If multiple non-location attributes are available, a single WBS region R may be associated with multiple location subsets for different combinations of partial identifiers and non-location attributes. As a result of step 210, each region R is associated with one or more combinations of partial identifiers and non-location attributes.

Once the WBS regions are preclassified based on corresponding partial identifiers and non-location attribute combinations, a disambiguation process may be initiated in order to ascertain which region is the properly associated region for an unknown mobile device providing a particular partial identifier. This process utilizes one or more non-location attributes from the mobile device, referred to herein as disambiguating signals, in conjunction with a partial identifier to select the region.

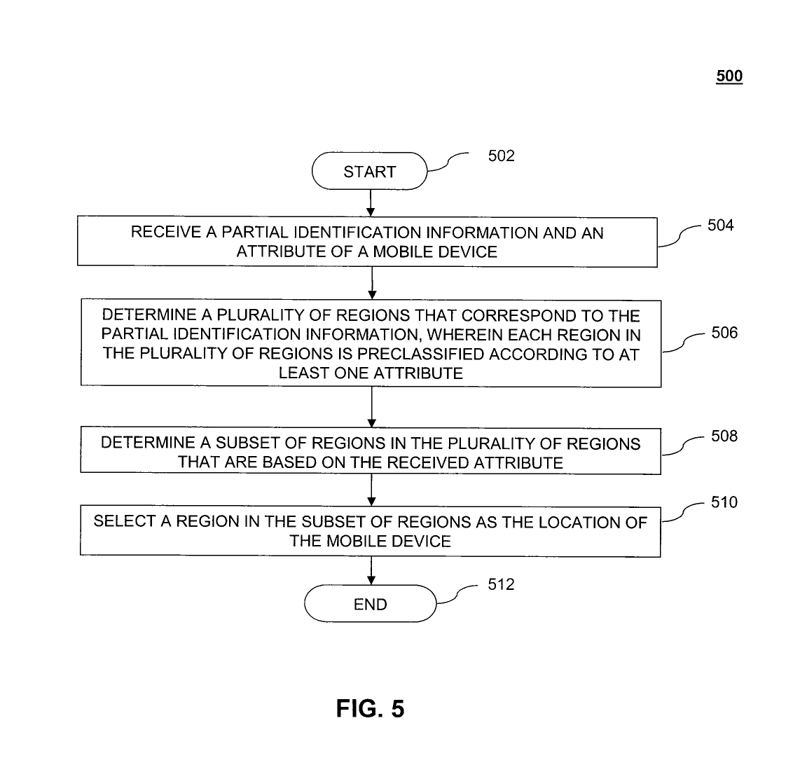

FIG. 5 illustrates an example disambiguating method 500 according to an embodiment of the present invention. Method 500 begins at step 502, and proceeds to step 504.

In step 504, a partial identifier, such as an LAC/CID data pair, is received for a mobile device, as well as a non-location attribute that can be used as a disambiguating signal.

In step 506, a plurality of geographic regions that correspond to the partial identifier is determined. Since the partial identifier is incomplete, such as including just the LAC/CID pair data, multiple geographic regions may be identified as corresponding to the partial identifier. Each of the identified regions has been pre-classified based on at least one non-location attribute that was identified and collected by, for example, method 200 of FIG. 2.

In step 508, a subset of regions corresponding to the received non-location attribute is determined from the plurality of regions obtained in step 506. The subset of regions is determined using the preclassification of regions by non-location attribute created by, for example, method 200 of FIG. 2. The subset of regions may be determined using one or more of the non-locational attributes. Varying weights may be given to each attribute based on thresholds and confidence levels associated with each attribute. A confidence level may be based on a variety of factors including, for example and without limitation, the number of data points that form the basis of a region, the fraction of data points that are used, the mean accuracy over all the data points and the mean confidence, the closeness of the data points, the difference between the threshold values and those actually used, the temporal distribution of the data points, the diversity of the data points, and/or other algorithm dependent measures. For example, the confidence score may be a normalized weighted linear combination of the factors, wherein the confidence score is a scalar value between 0 and 1. One of skill in the art will recognize that the confidence score may have a different range, may be a vector, or may be determined from a different type of algorithm without departing from the spirit and scope of the present invention.

An iterative approach to disambiguation may be used if it is determined that a number of locations in a subset of locations corresponding to a non-location attribute are likely to be erroneous. As an example, a determination may be made that a specific type of disambiguation signal is incorrect and location data may be assigned to a generic location set for which no disambiguation signal has been found.

In step 510, a region in the subset of regions determined in step 508 is selected as the location of the mobile device. In an embodiment, an associated confidence score which indicates the certainty of the inference of the specific region may be utilized in selecting the region. For example, in an embodiment, step 510 may include the use of a filter and/or a filter-boost algorithm which compares one region in the subset with another region in the subset, wherein the initial region's confidence score can be increased based on how closely the initial region matches the other region in terms of geographic coverage.

A filter algorithm, according to an embodiment of the present invention, operates by obtaining an output region R, location L, and confidence C for each partial identifier, without referring to a disambiguating non-location attribute. The algorithm then obtains an output region R(j), location L(j), and confidence C(j) for each non-location attribute j. For each region R(j), a new confidence score S(j) is obtained by comparing the sets of <region R(j), confidence C(j)> against the region and confidence score without the disambiguating signal. The region R(j) having the highest confidence score S(j) may be selected as the location of the mobile device.

A filter-boost algorithm according to an embodiment of the present invention may be based on the idea that the confidence score S(j) for region R(j) nominally equals its initial confidence score, confidence C(j). However, when the score is compared with another region, region R(k), the score can be boosted depending upon how closely region R(j) matches region R(k) in terms such as geographical coverage and that region's initial confidence score, confidence C(k). Therefore, the final confidence score for region R(j) is determined from the function score S(j)=confidence C(j)+Sum {i=0, max} {Boost (j,i)} where for convenience the function Boost (j,0) refers to comparison with region R(0)=region R. An example boost function is Boost (j,k)=[area(intersection(Rj,Rk))/area(Rj)]*[1+C(k)−C(j)]. In this example, area(R) is the area of region R in square meters, and intersection(R, P) is the intersection of geographic regions R and P.

As an example, in a given pair of regions Rj and Rk, Rj receives a boost from Rk. Rk receives an equal boost from Rj if C(j)=C(k), less boost if C(j)<C(k), and greater boost otherwise. Thus, boosts are not necessarily symmetric. Even if the boost for a particular pair Rj and Rk are in fact symmetric, the final confidence scores S(j) and S(k) may not be equal. If there are two regions Rj and Rk with equal final scores, there are a number of options that can be executed to select the proper region as the location of the mobile device. Such options include, for example and without limitation, breaking ties arbitrarily, serving each region with equal probability for each request and collecting some user data to determine which one seems more suitable, or simply not serving any region.

Another example of the boost function is Boost(j,k)=[area (intersection(Rj,Rk))/area(Rj)]*[1+C(j)*sum{C(k)}]. Other boost functions can be defined that are similar in spirit and scope and that may be suited to a particular system, technology, application set, and other factors.

The Filter-Boost algorithm as described is potentially computationally intensive and various standard computer science techniques can be used to make it faster without departing from the spirit and scope of the present invention. It is also possible to automatically tune the operation of the Filter algorithm using machine learning techniques.

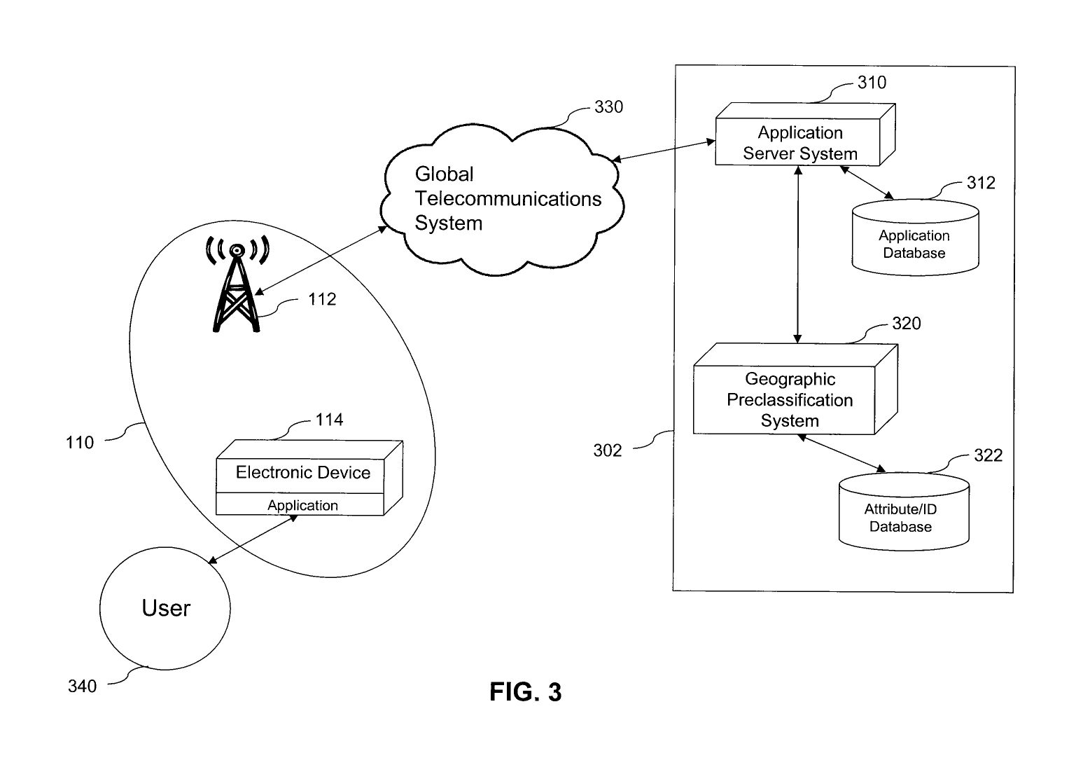

FIG. 3 illustrates a system 302 for determining the geographical location of an end user 340 utilizing information from the user's mobile device 114, according to an embodiment of the present invention. System 302 may be used, for example, to execute either or both of methods 200 and 500, described with respect to FIGS. 2 and 5, respectively. System 302 includes an application server system 310 and a geographic preclassification system 320. Application server system 310 is coupled to an application database 312. Geographic preclassification system 320 is coupled to an attribute/ID database 322. As referred to herein, a database can be a table, list, or any other collection of information known to one of skill in the art, whether represented, for example, as a flat file or a set of relational tables, lists, or records. Application server system 310 is in communication with a network 330. In an embodiment, network 330 is a telecommunications network. Application server system 310 receives information from wireless device 114 via network 330, which in turn receives information from WBS 112.

During a collection phase, such as that described with respect to method 200 of FIG. 2, a mobile device, such as device 114, may use an application program on device 114 to report its WBS region identification parameters such as MNC, MCC, LAC, and CID along with a location indication and a non-location attribute to system 302 via WBS 112 and network 330. If the identification data is complete then application server system 310 passes the location, identification data, and non-location attribute data to geographic preclassification system 320. Geographic pre-classification system 320 stores the data in attribute/ID database 322.

In an embodiment, when application server system 310 receives a request for another mobile device 114 to, for example, display a map of the device's location, application server system 310 may provide a partial identifier and a non-location attribute received from mobile device 114 to geographic preclassification system 320.

In order to determine a location of mobile device 114 based on the partial identifier received from mobile device 114, geographic preclassification system 320 may use method 500 of FIG. 5 to compare the received information to preclassified data. The preclassified data may be stored in and retrieved from, for example, attribute/ID database 322.

Once geographic preclassification system 320 returns the region associated with mobile device 114, application server system 310 may retrieve, for example, a map corresponding to the region from application database 312 and transmit the map to mobile device 114.

It is to be appreciated that the Detailed Description section, and not the

Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A method for determining a location of a mobile device, comprising:
receiving, from a plurality of mobile devices, complete identifications of regions and non-location attributes;
storing the complete identifications of regions and the non-location attributes in an electronic database;
electronically receiving partial identification information and a non-location attribute from a particular mobile device;
electronically determining a plurality of regions corresponding to the partial identification information;
electronically determining a subset of regions in the plurality of regions based on the received non-location attribute using the complete identifications of locations and the non-location attributes stored in the electronic database; and
electronically selecting a region in the subset of regions as the location of the particular mobile device, wherein each region in the plurality of regions corresponds to a physical area and is classified according to one or more non-location attributes, and wherein each region in the plurality of regions is associated with a separate distinct wireless base station, and wherein the non-location attribute received from the particular mobile device is independent of signals transmitted from the wireless base stations with which the plurality of regions are associated.

2. The method of claim 1, wherein a weighted importance is given to a non-location attribute based on at least one of a threshold or a confidence level associated with each non-location attribute.

3. The system of claim 2, wherein the confidence level is based on at least one of:
a quantity of data points which form the basis of a region;
a fraction of the data points;
a mean accuracy of the data points;
a mean confidence of the data points;
a closeness of the data points; or a diversity of the data points.

4. The method of claim 1, wherein the complete identification information comprises at least one of:
a mobile network code (MNC);
a mobile country code (MCC);
a local area code (LAC);
a cell identification (CID); and
data from a global positioning system within a mobile communication device.

5. The method of claim 1, where the non-location attribute comprises at least one of:
an Internet Protocol (IP) address block used by the mobile communication device;
a radio type of the mobile communication device;
a hardware platform used by the mobile communication device; a software program used by the mobile communication device; a language used by the mobile communication device;
an application software program used by the mobile communication device;
a carrier name associated with the mobile communication device; a time zone indicated by the mobile communication device;
a time format indicated by the mobile communication device;
a date format indicated by the mobile communication device;
a time delay synchronization required by the mobile communication device; or
a rate of received data.

6. The method of claim 1, further comprising:
retrieving a map corresponding to the selected region; and
relaying the map to the particular mobile communication device.

7. The method of claim 1, further comprising retrieving location information corresponding to the selected region and relaying the location information to the particular mobile communication device.

8. The method of claim 1, further comprising retrieving location information corresponding to the selected region and transmitting a location-based service to the particular mobile communication device.

9-16. (canceled)

17. A system, comprising:
a processor; and
a memory in communication with the processor, the memory storing a plurality of processing instructions for directing the processor to:
gather complete regional identification information and a plurality of non-location attributes associated with a corresponding plurality of mobile communication devices;
determine one or more defined regions which correspond to the regional identification information received from the plurality of mobile communication devices, wherein each region of the plurality of defined regions is classified according to the non-location attribute, and wherein each region of the plurality of defined regions corresponds to a physical area, and wherein each region of the plurality of defined regions is associated with a separate distinct wireless base station;
receive partial identification information and a non-location attribute from a particular mobile device, wherein the non-location attribute is independent of wireless signals transmitted within a region in which the particular mobile device is located;
determine a plurality of regions corresponding to the partial identification information;
determine a subset of regions in the plurality of regions based on the received attribute using the gathered complete regional identification information and the plurality of non-location attributes; and
select a region in the subset of regions as the location of the particular mobile device.

18. The system of claim 17, wherein the plurality of non-location attributes each given a weighted importance based on at least one of a threshold or a confidence level.

19. The system of claim 18, wherein the confidence level is based on at least one of:
a quantity of data points which form the basis of a region;
a mean accuracy of the data points;
a mean confidence of the data points;
a closeness of the data points; or
a diversity of the data points.

20. The system of claim 17, wherein the complete identification information comprises at least one of:
a mobile network code (MNC);
a mobile country code (MCC);
a local area code (LAC);
a cell identification (CID); and
data from a global positioning system within a mobile communication device

21. The system of claim 17, where the non-location attribute comprises at least one of:
an Internet Protocol (IP) address block used by the mobile communication device;
a radio type of the mobile communication device;
a hardware platform used by the mobile communication device; a software program used by the mobile communication device; a language used by used by the mobile communication device; an application software program used by the mobile communication device;
a carrier name associated with the mobile communication device; a time zone indicated by the mobile communication device;
a time format indicated by the mobile communication device;
a date format indicated by the mobile communication device;
a time delay synchronization required by the mobile communication device; or
a rate of received data.

22. The system of claim 17, farther comprising directing the processor to retrieve a map corresponding to the selected region and relay the map to the particular mobile communication device.

23. The system of claim 17, further comprising directing the processor to retrieve location information corresponding to the selected region and relay the location information to the particular mobile communication device.

24. The system of claim 17, further comprising directing the processor to retrieve location information corresponding to the selected region and transmit a location-based service to the particular mobile communication device.

25. The method of claim 1, further comprising:
classifying the plurality of regions according to the non-location attributes using the complete identifications of locations and non-location attributes received from the plurality of mobile devices, including, for a given partial identifier, determining a set of locations associated with the given partial identifier and the non-location attribute, wherein the given partial identifier is a portion of the corresponding complete identification.

26. The method of claim 25, wherein each combination of a partial identifier and a non-location attribute corresponds to a subset of locations, the method further comprising determining a region encompassing the subset of locations for each of the combination.

27. The method of claim 5, wherein the complete identification of the region includes each of the MNC, the MNC, the LAC, and the CID.

28. The system of claim 17, wherein the plurality of processing instructions are for further directing the processor to:
classify the plurality of regions according to the non-location attributes using the complete identifications of locations and non-location attributes received from the plurality of mobile devices, including, for a given partial identifier, determine a set of locations associated with the given partial identifier and the non-location attribute, wherein the given partial identifier is a portion of the corresponding complete identification.

29. The system of claim 27, wherein each combination of a partial identifier and a non-location attribute corresponds to a subset of locations, the plurality of processing instructions being for further directing the processor to determine a region encompassing the subset of locations for each of the combinations.

30. The system of claim 17, wherein the complete identification of the region includes each of the MNC, the MNC, the LAC, and the CID.
